(19) United States
(12) Patent Application Publication
(10) Pub. No.: US 2025/0375831 A1
(43) Pub. Date: Dec. 11, 2025

(54) ONE-STEP INDUCTION WELDING ASSEMBLY CONFIGURATION FOR A BATTERY ENCLOSURE

(71) Applicant: GM Global Technology Operations LLC, Detroit, MI (US)

(72) Inventors: Robin James, Rochester Hills, MI (US); Mary Gilliam, Farmington Hills, MI (US); Ryan Gergely, Fraser, MI (US); Selina Xinyue Zhao, Rochester Hills, MI (US)

(21) Appl. No.: 18/738,604

(22) Filed: Jun. 10, 2024

(51) Int. Cl. B23K 13/01; B60L 50/64; H01M 10/613; H01M 10/625; H01M 10/6554; H01M 10/6556; H01M 50/224; H01M 50/227; H01M 50/229; H01M 50/231; H01M 50/249

(52) U.S. Cl. CPC B23K 13/01; H01M 10/613; H01M 10/625; H01M 10/6554; H01M 10/6556; H01M 50/224; H01M 50/227; H01M 50/229; H01M 50/231; H01M 50/249; B60L 50/64; H01M 2220/20

(57) ABSTRACT

A one-step induction welding assembly configuration for a battery enclosure includes a tray constructed of a constructed of thermoplastic composite material. The tray is part of the battery enclosure. The one-step induction welding assembly configuration also includes a cooling component constructed of one of the following: thermoplastic composite material and metal, where the cooling component is joined to the tray at a joining interface, and the cooling component is part of the battery enclosure. The one-step induction welding assembly configuration also includes a plurality of induction coils that are energized to create an electromagnetic field that generates heat and joins the tray and the cooling component together at the joining interface, a layer of electrically insulating material disposed directly underneath the plurality of induction coils, and a die that exerts a clamping force against the tray of the battery enclosure.

### INTRODUCTION

The present disclosure relates to a one-step induction welding assembly configuration for a battery enclosure, and towards battery enclosures fabricated by the one-step induction welding assembly configuration.

### BACKGROUND

Battery enclosures for electric vehicles have traditionally been constructed from metal materials such as, for example, aluminum and steel. However, it is to be appreciated that metal tends to introduce a large amount of mass to an electric vehicle. Furthermore, it may be challenging to form complex shapes that are often required for a battery enclosure with metal. As a result, battery enclosures may be constructed from materials other than metal as well, such as thermoplastic composites.

Several joining techniques currently exist for either joining thermoplastic components together or with another metal component, however, existing joining techniques may have drawbacks. For example, one joining technique that may be used is resistance welding. However, resistance welding requires a resistive element such as metal or carbon fiber that stays in the weld. Another joining technique is ultrasonic welding, which requires an energy director at the interface of the weld. Laser welding is another joining technique that may be employed as well. However, laser welding requires at least one adherent to be laser transparent. Another joining technique currently available is adhesive bonding. However, adhesive bonding introduces material to the battery enclosure, which adds to the mass and volume of the vehicle. Furthermore, adhesive bonding also makes it more difficult to separate materials at the end of the life for reclaiming.

Thus, while battery enclosures achieve their intended purpose, there is a need in the art for an improved approach for fabricating a battery enclosure.

### SUMMARY

According to several aspects, a one-step induction welding assembly configuration for a battery enclosure is disclosed, and includes a tray constructed of a constructed of thermoplastic composite material, where the tray is part of the battery enclosure. The one-step induction welding assembly configuration also includes a cooling plate constructed of one of the following: thermoplastic composite material and metal, where the cooling plate is joined to the tray at a joining interface, and where the cooling plate is part of the battery enclosure. The one-step induction welding assembly configuration includes a plurality of induction coils that are energized to create an electromagnetic field that generates heat and joins the tray and the cooling plate together at the joining interface, a layer of electrically insulating material disposed directly underneath the plurality of induction coils, and a die that exerts a clamping force against the tray of the battery enclosure, wherein the plurality of induction coils exerts a force that directly opposes the clamping force to retain the tray and the cooling plate in place.

In another aspect, the cooling plate is constructed of the thermoplastic composite material.

In yet another aspect, the one-step induction welding assembly configuration includes an electrically conductive plate including an upper surface and a lower surface, wherein the upper surface of the electrically conductive plate contacts a lower surface of the layer of electrically insulating material and the lower surface of the electrically conductive plate contacts an upper surface of the cooling plate.

In another aspect, a thermal resistance through the cooling plate does not exceed 3.0×10⁻³ m²KW⁻¹ at 65° C.

In yet another aspect, the cooling plate is constructed of metal.

In an aspect, a lower surface of the layer of electrically insulating material contacts an upper surface of the cooling plate.

In another aspect, the tray includes base, and wherein a plurality of cooling features extends along at least a portion of the base.

In yet another aspect, the plurality of cooling features include a plurality of cooling channels, and where each cooling channel is a passageway shaped to receive a cooling medium.

In an aspect, raised surfaces are interposed between the plurality of cooling channels disposed along the base of the tray.

In another aspect, the raised surfaces interposed between the plurality of cooling channels located along the base of the tray contact the lower surface of the cooling plate at the joining interface.

In yet another aspect, the raised surfaces of the tray includes one of the following: a higher average surface roughness value when compared to a remaining portion of the tray, and an increased surface energy when compared to the remaining portion of the tray.

In an aspect, the cooling plate includes an upper surface that includes one of the following: a higher average surface roughness value when compared to a remaining portion of the cooling plate, and an increased surface energy when compared to the remaining portion of the cooling plate.

In another aspect, the tray is constructed of a thermoplastic composite laminate including a thermoplastic composite layer and at least one of the following: a thermal runaway propagation (TRP) protective layer, TRP protective materials, and an electromagnetic interference (EMI) shielding layer.

In an aspect, a one-step induction welding assembly configuration for a battery enclosure is disclosed, and includes a tray constructed of a constructed of thermoplastic composite material, where the tray is part of the battery enclosure. The one-step induction welding assembly configuration includes a cross-rail constructed of one of the following: thermoplastic composite material and metal, where the cross-rail is joined to the tray at a joining interface, and the cross-rail is part of the battery enclosure. The one-step induction welding assembly configuration includes a plurality of induction coils that are energized to create an electromagnetic field that generates heat and joins the tray and the cross-rail together at the joining interface. The one-step induction welding assembly configuration includes a layer of electrically insulating material disposed directly underneath the plurality of induction coils, and a die that exerts a clamping force against the cross-rail of the battery enclosure, wherein the plurality of induction coils exerts a force that directly opposes the clamping force to retain the tray and the cross-rail in place.

In another aspect, the cross-rail includes a flange.

In yet another aspect, the one-step induction welding assembly configuration includes an electrically conductive plate disposed between the tray of the battery enclosure and the layer of electrically insulating material.

In an aspect, a one-step induction welding assembly configuration for a battery enclosure is disclosed and includes a first component and a second component that are positioned coplanar with respect to one another, where the first component and the second component are joined together at an interlocking joining interface. The one-step induction welding assembly configuration includes an induction coil energized to create an electromagnetic field that generates heat and joins the first component and the second component together at the interlocking joining interface. The one-step induction welding assembly configuration includes an insulating clamp constructed of an electrically insulating material, where the insulating clamp exerts clamping force upon the interlocking joining interface between the first component and the second component, and a base plate fixture constructed of an electrically insulating material, where the induction coil is recessed within the base plate fixture and the base plate fixture remains stationary as the clamping force is exerted against the first and second components by the insulating clamp.

In another aspect, the one-step induction welding assembly configuration includes an electrically conductive plate constructed of an electrically conductive material and including a planar profile defining an upper surface and a lower surface, where the upper surface of the electrically conductive plate contacts the first component and second component.

In yet another aspect, the electrically conductive plate includes a length and a width that extend beyond a total length and a total width of the interlocking joining interface that joins the first component and the second component together.

In an aspect, the electrically conductive plate is constructed of at least one of the following materials for providing EMI shielding: a metal film, sheet metal, and a metallic mesh material, and wherein the electrically conductive plate is joined to the first component and the second component during one-step induction welding.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed battery enclosure, according to an exemplary embodiment;

FIG. 2A is an exploded, perspective view of one embodiment of the battery enclosure including a tray and a cooling plate, according to an exemplary embodiment;

FIG. 2B is a perspective view of the battery enclosure shown in FIG. 2A where the tray and cooling plate are joined to one another, according to an exemplary embodiment;

FIG. 3 is a perspective view of the tray of the battery enclosure shown in FIGS. 2A and 2B, according to an exemplary embodiment;

FIG. 4 is a schematic diagram of a thermoplastic composite laminate of the tray shown in FIG. 3, according to an exemplary embodiment;

FIG. 5 is a schematic diagram illustrating an exemplary one-step induction welding assembly configuration for joining the tray with the cooling plate of the battery enclosure shown in FIGS. 2A, 2B, and 3, according to an exemplary embodiment;

FIG. 6 is a side view of an embodiment of an induction coil that is a solenoid coil, according to an exemplary embodiment;

FIG. 7 is an elevated perspective view of another embodiment of the battery enclosure shown in FIG. 1, according to an exemplary embodiment;

FIG. 8 is a schematic diagram illustrating another embodiment of the one-step induction welding assembly configuration for the battery enclosure shown in FIG. 7, according to an exemplary embodiment;

FIG. 9 is a top view of a schematic diagram illustrating another embodiment of the one-step induction welding assembly configuration for joining together two coplanar components together at an interlocking joining interface, where an insulating clamp and a constraining plate have been omitted, according to an exemplary embodiment;

FIG. 10 is a top view the one-step induction welding assembly configuration shown in FIG. 9 including the insulating clamp and the constraining plate, according to an exemplary embodiment;

FIG. 11 illustrates the one-step induction welding assembly configuration taken along section A-A in FIG. 10, according to an exemplary embodiment;

FIG. 12 illustrates the one-step induction welding assembly configuration taken along section B-B in FIG. 10, according to an exemplary embodiment; and

FIG. 13 illustrates the detail of Area C-C in FIG. 11, according to an exemplary embodiment.

### DETAILED DESCRIPTION

The following description is merely exemplary in nature and is not intended to limit the present disclosure, application, or uses.

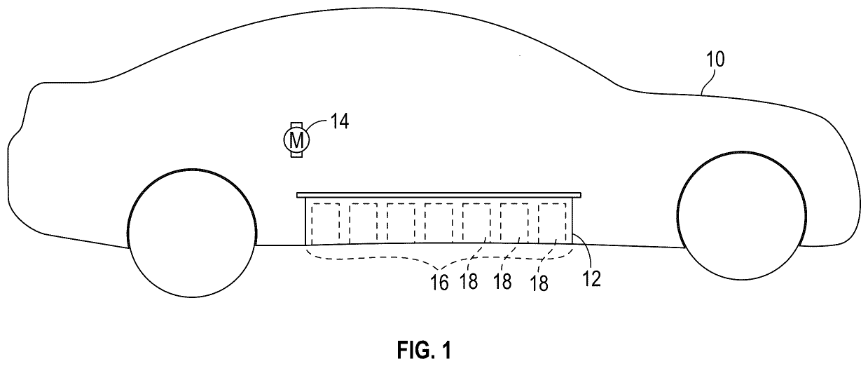

Referring to FIG. 1, a schematic diagram of a vehicle 10 including an exemplary battery enclosure 12 for providing power to one or more electric motors 14 is illustrated. It is to be appreciated that although the vehicle 10 is illustrated as a sedan, the vehicle 10 may be any other type of vehicle such as, but not limited to, a truck, sport utility vehicle, van, or motor home. The battery enclosure 12 contains a battery pack 16. The battery pack 16 includes a plurality of battery modules 18 that are electrically connected to one another. Although a vehicle 10 is described and illustrated in FIG. 1, it is to be appreciated that the battery enclosure 12 is not limited to a vehicle and may be employed in other applications as well. Indeed, the battery enclosure 12 may be used in a variety of other electromobility and stationary applications.

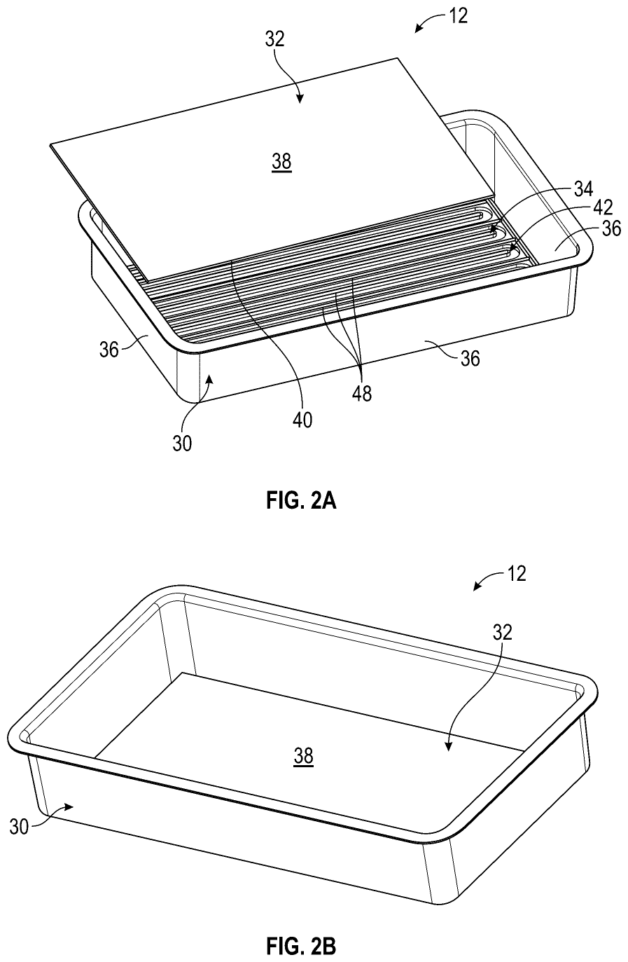

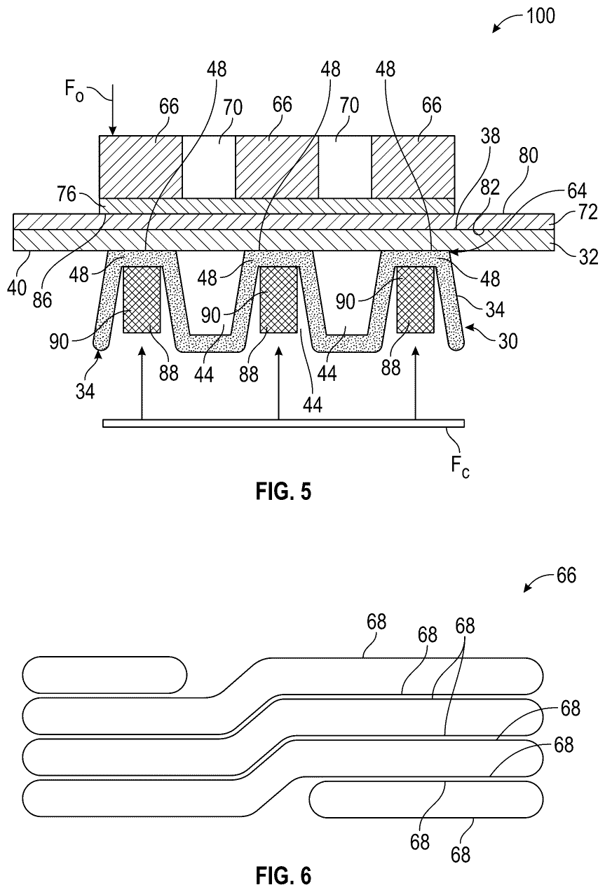

FIG. 2A is a perspective, exploded view of one embodiment of the battery enclosure 12 shown in FIG. 1 and FIG. 2B is an assembled view of the battery enclosure 12 shown in FIG. 2A. Referring to FIGS. 1, 2A, and 2B, the battery enclosure 12 includes a tray 30 and a cooling plate 32. The tray 30 is shaped to contain the battery pack 16. The tray 30 includes a base 34 and a plurality of sides 36, where the sides 36 of the tray 30 surround the battery pack 16. Referring specifically to FIG. 2B, the cooling plate 32 is joined to the base 34 of the tray 30 by a one-step induction welding assembly configuration 100 shown in FIG. 5, which is described below. Referring to FIGS. 2A and 2B, the cooling plate 32 defines an upper surface 38 and a lower surface 40, where the battery pack 16 (FIG. 1) is located against the upper surface 38 of the cooling plate 32. In exemplary embodiment as shown in the figures, the base 34 of the tray 30 and the cooling plate 32 both include a rectangular profile, however, it is to be appreciated that FIG. 2 is merely exemplary in nature, and the base 34 of the tray 30 and cooling plate 32 may include other profiles as well such as, for example, a square profile.

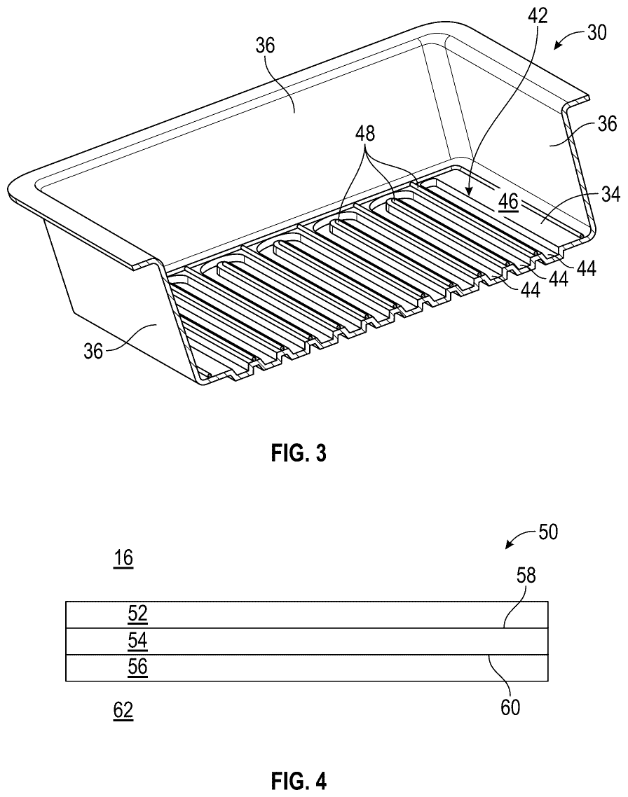

FIG. 3 is a cross-sectioned view of the tray 30 of the battery enclosure 12. A plurality of cooling features 42 extend along at least a portion of the base 34 of the tray 30, where the cooling features 42 are configured to draw heat away from the battery pack 16 (shown in FIG. 1) supported by the cooling plate 32 (shown in FIGS. 2A and 2B). In the embodiment as illustrated, the cooling features 42 include a plurality of cooling channels 44. The plurality of cooling channels 44 are formed within a wall 46 located along the base 34 of the tray 30, where each cooling channel 44 is a passageway that is shaped to receive a cooling medium. Referring to FIGS. 2A and 3, a raised surface 48 is interposed between the cooling channels 44 disposed along the base 34 of the tray 30. The raised surfaces 48 interposed between the plurality of cooling channels 44 are joined to the bottom surface 40 of the cooling plate 32 by a weld joint created during the one-step induction welding assembly configuration 100 shown in FIG. 5 described below.

In one embodiment, the tray 30 of the battery enclosure 12 is constructed of a thermoplastic composite including a fiber reinforcement and a matrix material. In one embodiment, the fiber reinforcement of the thermoplastic composite is an electrically conductive material including continuous carbon fibers, discontinuous carbon fibers, or both continuous and discontinuous carbon fibers. Other examples of electrically conductive materials that may be used as the fiber reinforcement include, but are not limited to, metal coated glass fiber (such as copper or nickel coated glass fiber) and natural fibers having electrical conductivity. It is to be appreciated that either the tray 30 or the cooling plate 32, or both the tray 30 and the cooling plate 32, are constructed of an electrically conductive material to enable induction welding. Thus, in another embodiment, the cooling plate 32 is constructed of an electrically conductive material such as metal and the tray 30 may include either electrically conductive or nonconductive fiber reinforcement. When the cooling plate 32 is constructed of metal, the cooling plate 32 includes an electrically insulating layer to provide electrical insulation from the battery pack 16 (shown in FIG. 1). In one embodiment, the matrix material of the thermoplastic composite includes one or more of the following: polyether ether ketone (PEEK), polyether ketone ketone (PEKK), polyphenylene sulfide (PPS), polyether imide (PEI), perfluoro alkoxy polymer (PFA), polytetrafluoroethylene (PTFE), polyaryletherketone (PAEK), polyethylene (PE), polybutylene terephthalate (PBT), polypropylene (PP), polyamide (PA), and polyacrylonitrile (PAN).

In one non-limiting embodiment, the tray 30 of the battery enclosure is constructed of a thermoplastic composite laminate 50, which is shown in FIG. 4. Referring to FIG. 4, the thermoplastic composite laminate 50 includes a thermal runaway propagation (TRP) protective layer 52, a thermoplastic composite layer 54, and an electromagnetic interference (EMI) shielding layer 56. The TRP protective layer 52 of the thermoplastic composite laminate 50 is constructed of materials that provide passive prevention of thermal runaway propagation of the battery pack 16 (FIGS. 2 and 3) such as, for example, a fabric impregnated with or completely constructed of materials that provide thermal incident resistance such as, for example, aluminum tetrahydrate, ammonium polyphosphate, ammonium sulfate, melamine cyanurate, sodium silicates, metal hydroxides, metal oxides (e.g., titanium dioxide), clay, calcium silicate, kaolin, and hydrated silica, as well as compounds based on phosphorous, nitrogen, antimony, boron, zinc, or halogens such as bromine and chlorine. In some examples, the TRP protective layer 52 is constructed of a mineral or ceramic material embedded in a resin or as a rigid plate, such as a mica plate. The TRP protective layer 52 may also be constructed of an intumescent material system including materials that create an insulating char, including an acid source, a carbon source, and a blowing agent. Although FIG. 4 illustrates the thermoplastic composite laminate 50 including a TRP protective layer 52, in the alternative the TRP protective materials may be included as part of the thermoplastic composite laminate 50. The EMI shielding layer 56 is constructed of materials that shield the battery pack 16 from electromagnetic interference such as, for example, metal film, sheet metal, or a metallic mesh material. In an embodiment, the thermoplastic composite laminate 50 may be created by processes such as, but not limited to, compression molding, injection molding, extrusion, or pultrusion.

The thermoplastic composite layer 54 defines a first, interior surface 58 that faces the interior of the tray 30 where the battery pack 16 (FIG. 1) is located and a second, exterior surface 60 that faces an exterior environment 62. The TRP protective layer 52 of the thermoplastic composite laminate 50 is disposed along the interior surface 58 of the thermoplastic composite layer 54 and the EMI shielding layer 56 is disposed along the exterior surface 60 of the thermoplastic composite layer 54. It is to be appreciated that the TRP protective layer 52 and the EMI shielding layer 56 are both optional layers that may be omitted in some embodiments. In embodiments, the TRP protective layer 52 and the EMI shielding layer 56 may be incorporated into the thermoplastic composite layer 54 during the one-step induction welding assembly configuration 100 shown in FIG. 5.

Referring to FIGS. 2A and 2B, the cooling plate 32 may be constructed of either a thermoplastic composite or a metal. When the cooling plate 32 is constructed of thermoplastic composite, in one embodiment the fiber reinforcement of the thermoplastic composite may include continuous carbon fibers, discontinuous carbon fibers, or both continuous and discontinuous carbon fibers. In another embodiment, the thermoplastic composite may include one or more thermally conductive materials such as, but not limited to, metal powders, carbon fillers, aluminum oxide, boron nitride, silicon carbide, aluminum nitride, boron phosphate, thermally conductive silicone compounds, and thermally conductive polymers. In an embodiment, the upper surface 38 of the cooling plate 32 includes glass fibers to provide electrical insulation. In one embodiment, the matrix material of the thermoplastic composite includes one or more of the following: PEEK, PEKK, PAEK, PPS, PEI, PFA, PTFE, and PAN. In another embodiment, the cooling plate 32 is constructed of metals such as, but not limited to, aluminum and steel. In an embodiment where the cooling plate 32 is constructed of metal, the upper surface 38 of the cooling plate 32 is coated with an electrically insulating layer. It is to be appreciated that when the cooling plate 32 is constructed of metal and is coated with the electrical insulating material, or when the cooling plate 32 is constructed of the thermoplastic composite, the thermal resistance through the cooling plate 32 does not exceed 3.0×10⁻³ m²KW⁻¹ at 65° C.

In one embodiment, if the cooling plate 32 is constructed of metal or a dissimilar thermoplastic composite when compared to the thermoplastic composite of the tray 30, then either the lower surface 40 of the cooling plate 32, the raised surfaces 48 interposed between the cooling channels 44 located along the base 34 of the tray 30, or both may undergo one or more surface modification treatment techniques. In one embodiment, the surface modification treatment technique is a mechanical abrasion technique or a laser texturing technique that increases the average surface roughness values (Ra) of the lower surface 40 of the cooling plate 32 and/or the raised surfaces 48 of the tray 30, which in turn enhances the bonding between the tray 30 and the lower surface 40 of the cooling plate 32 during the one-step induction welding assembly configuration 100 shown in FIG. 5. Therefore, it is to be appreciated that the lower surface 40 of the cooling plate 32 includes a higher average surface roughness value when compared to the average surface roughness value of the upper surface 38 of the cooling plate 32 (i.e., the remaining portion of the cooling plate 32). Similarly, the raised surfaces 48 of the tray 30 include a higher average surface roughness value when compared to the average surface roughness value of the remaining portion of the tray 30.

In another embodiment, the surface modification treatment technique is a plasma treatment, a flame treatment, or a laser cleaning treatment that result in an increased surface energy of the lower surface 40 of the cooling plate 32 when compared to the remaining portion of the cooling plate 32 and/or the raised surfaces 48 of the tray 30 when compared to the remaining portion of the tray 30, which in turn enhances the bonding between the tray 30 and the lower surface 40 of the cooling plate 32 during the one-step induction welding assembly configuration 100 shown in FIG. 5.

FIG. 5 is a schematic diagram illustrating an exemplary one-step induction welding assembly configuration 100 for joining the tray 30 with the cooling plate 32 of the battery enclosure 12 shown in FIGS. 2A, 2B, and 3. Specifically, referring to both FIGS. 3 and 5, the cooling plate 32 is positioned relative to the tray 30 so the raised surfaces 48 interposed between the cooling channels 44 located along the base 34 of the tray 30 contact the lower surface 40 of the cooling plate 32 at a joining interface 64. As seen in FIG. 5, a plurality of induction coils 66 are positioned to face the upper surface 38 of the cooling plate 32, where the plurality of induction coils 66 include internal cooling features (not shown). In one example, the internal cooling features employ coolant such as water that flows through each induction coil 66. The plurality of induction coils 66 are energized by a radio-frequency electric current created by an energy source (not shown) to create an electromagnetic field that generates heat and joins the tray 30 and the cooling plate 32 together at the joining interface 64.

FIG. 6 is a side schematic view of an embodiment of an exemplary induction coil 66 that is a solenoid coil. It is to be appreciated that the induction coil 66 is shaped to correspond to the geometry of the surfaces that are being joined together. In the embodiment as shown, the induction coil 66 includes two legs 68 that are oriented parallel with respect to one another.

Turning back to FIG. 5, the plurality of induction coils 66 are constructed of an electrically conductive material such as, for example, copper. An electrically insulating material 70 is disposed between each induction coil 66. The electrically insulating material 70 may be constructed of electrically insulating materials such as, for example, a glass-reinforced fiber-epoxy laminate G-10 or a glass-reinforced polyester such as GPO3. As seen in FIG. 5, an electrically conductive plate 72 is disposed between the cooling plate 32 of the battery enclosure 12 and a layer of electrically insulating material 76, where the layer of electrically insulating material 76 is positioned directly underneath the plurality of induction coils 66.

The electrically conductive plate 72 includes an upper surface 80 and a lower surface 82. The upper surface 80 of the electrically conductive plate 72 contacts a lower surface 86 of the layer of electrically insulating material 76 and the lower surface 82 of the electrically conductive plate 72 contacts the upper surface 38 of the cooling plate 32. In one embodiment, the electrically conductive plate 72 is included as part of the one-step induction welding assembly configuration 100 for securing the tray 30 with the cooling plate 32 when the cooling plate 32 is constructed of a thermoplastic composite. That is, when the cooling plate 32 is constructed of metal, the electrically conductive plate 72 is omitted from the one-step induction welding assembly configuration, the lower surface 86 of the layer of electrically insulating material 76 directly contacts the upper surface 38 of the cooling plate 32. However, in some embodiments, the tray 30 may be secured to the cooling plate 32 without the electrically conductive plate 72 when the cooling plate 32 is constructed of a thermoplastic material. The electrically conductive plate 72 is constructed of a electrically conductive material such as, but not limited to, steel or aluminum. It is to be appreciated that the specific electrically conductive material that the electrically conductive plate 72 is constructed of depends upon factors such as, but not limited to, thermal and electrical conductivity. It is also to be appreciated that the dimensions of the electrically conductive plate 72 are dependent upon the specific application.

The one-step induction welding assembly configuration 100 also includes a die 88 that exerts a clamping force F_{c} against the tray 30. In the example as shown in FIG. 5, the clamping force F_{c} is oriented in an upwards direction towards the tray 30. The die 88 includes individual blocks 90 that each exert the clamping force F_{c} against the raised surfaces 48 interposed between the cooling channels 44 located along the base 34 of the tray 30. The plurality of induction coils 66 exerts a force Fₒ that directly opposes the clamping force F_{c} to retain the tray 30 and cooling plate 32 in place as the tray 30 and the cooling plate 32 are joined together at the joining interface 64.

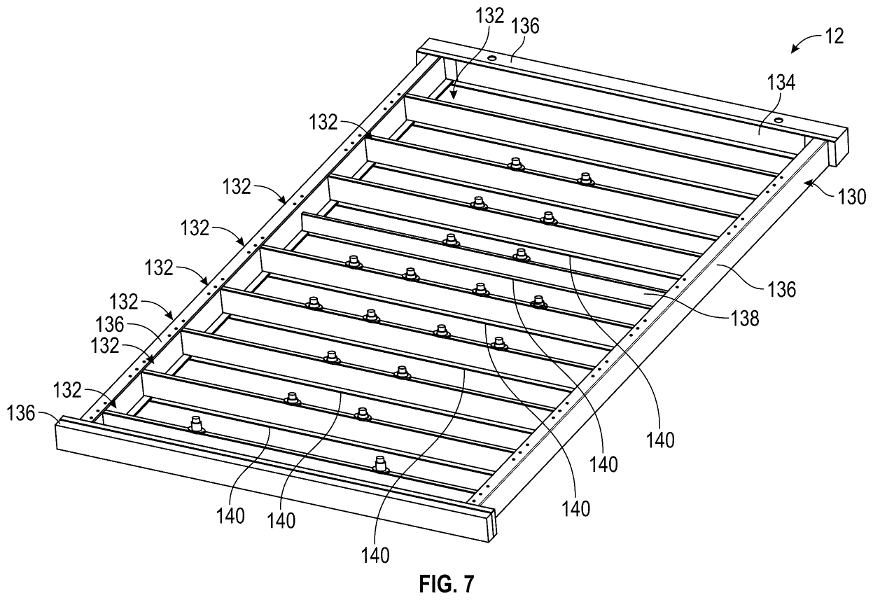

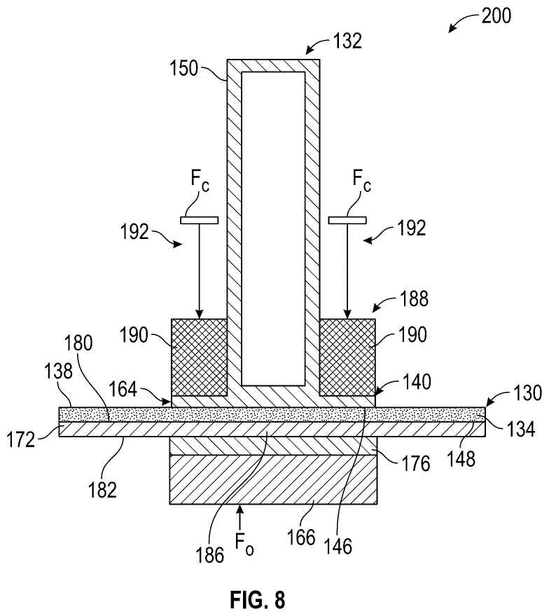

FIG. 7 is an elevated perspective view of another embodiment of the battery enclosure 12 shown in FIG. 1. Referring to FIGS. 1 and 7, the battery enclosure 12 includes a tray 130 and a plurality of cross-rails 132. The tray 130 is shaped to contain the battery pack 16, where the cross-rails 132 are positioned between the battery modules 18. The tray 130 includes a base 134 and a plurality of sides 136, where the sides 36 of the tray 30 surround the battery pack 16. The plurality of cross-rails are each joined to the base 134 of the tray 130 by a one-step induction welding assembly configuration 200 shown in FIG. 8, which is described below.

The tray 130 of the battery enclosure 12 is constructed of a thermoplastic composite including a fiber reinforcement and a matrix material. In one embodiment, the fiber reinforcement of the thermoplastic composite includes continuous carbon fibers, discontinuous carbon fibers, or both continuous and discontinuous carbon fibers. In one embodiment, the matrix material of the thermoplastic composite includes one or more of the following: PEEK, PEKK, PAEK, PPS, PEI, PFA, PTFE, PA, PP, PE, PBT, and PAN. In one non-limiting embodiment, the tray 130 of the battery enclosure 12 is constructed of the thermoplastic composite laminate illustrated in FIG. 4.

The plurality of cross-rails 132 may be constructed of a thermoplastic composite or a metal. It is to be appreciated that the plurality of cross-rails 132 include a plurality of internal cooling channels (not shown in the figures) that draw heat from the battery modules 18 of the battery pack 16 (shown in FIG. 1). When the plurality of cross-rails 132 are constructed of thermoplastic composite, the fiber reinforcement of the thermoplastic composite may include continuous carbon fibers, discontinuous carbon fibers, or both continuous and discontinuous carbon fibers. In one embodiment, the matrix material of the thermoplastic composite includes one or more of the following: PEEK, PEKK, PAEK, PPS, PEI, PFA, PTFE, PA, PP, PE, PBT, and PAN. In another embodiment, the plurality of cross-rails 132 are constructed of metals such as, but not limited to, aluminum and steel.

Referring to both FIGS. 7 and 8, each of the plurality of cross-rails 132 include a flange 140 attached to a bottom surface 138 of the base 134 of the tray 130 by the one-step induction welding assembly configuration 200 shown in FIG. 8. Specifically, as seen in FIG. 8, the flange 140 of each cross-rail 132 defines a lower surface 146, where the lower surface 146 of the flange 140 of the cross-rail 132 is joined to the bottom surface 138 of the tray 130 at a joining interface 164.

In one embodiment, if the cross-rails 132 are constructed of metal or a dissimilar thermoplastic composite when compared to the thermoplastic composite of the tray 130, then either the lower surface 146 of each cross-rail 132, the bottom surface 138 of the base 134 of the tray 130, or both may undergo one or more surface modification treatment techniques. In one embodiment, the surface modification treatment technique is a mechanical abrasion technique or a laser texturing technique that increases the average surface roughness values (Ra) of the lower surface 146 of each cross-rail 132 and/or the bottom surface 138 of the tray 130, which in turn enhances the bonding between the bottom surface 138 of the tray 30 and the lower surface 146 of the cross-rail 132 during the one-step induction welding assembly configuration 100 shown in FIG. 8. Therefore, it is to be appreciated that the lower surface 146 of each cross-rail 132 includes a higher average surface roughness value when compared to the average surface roughness value of a remaining outer surface 150 (FIG. 8) of each cross-rail 132. Similarly, the bottom surface 138 of the base 134 of the tray 130 includes a higher average surface roughness value when compared to the remaining portion of the tray 130.

In another embodiment, the surface modification treatment technique is a plasma treatment, a flame treatment, or a laser cleaning treatment that increases the surface energy of the lower surface 146 of each cross-rail 132 and/or the bottom surface 138 of the tray 130, which in turn enhances the bonding between the bottom surface 138 of the tray 30 and the lower surface 146 of the cross-rail 132 during the one-step induction welding assembly configuration 100 shown in FIG. 8.

FIG. 8 is a schematic diagram illustrating the exemplary one-step induction welding assembly configuration 200 for joining the tray 130 with the one of the plurality of cross-rails 132 of the battery enclosure 12 shown in FIG. 7. A plurality of induction coils 166 are positioned on the same side as an outer surface 148 of the tray 130. The plurality of induction coils 166 are energized by a radio-frequency electric current to create an electromagnetic field that generates heat and joins the tray 130 and the cross-rails 132 together at the joining interface 164.

A layer of electrically insulating material 176 is positioned directly underneath the plurality of induction coils 166. As seen in FIG. 8, an electrically conductive plate 172 is disposed between the base 134 of the tray 130 of the battery enclosure 12 and the layer of electrically insulating material 176. The electrically conductive plate 172 includes an upper surface 180 and a lower surface 182. The upper surface 180 of the electrically conductive plate 172 contacts the outer surface 148 of the base 134 of the tray 130 and the lower surface 182 of the electrically conductive plate 172 contacts an upper surface 186 of the layer of electrically insulating material 176. Similar to the embodiment shown in FIG. 5, the electrically conductive plate 172 is included as part of the one-step induction welding assembly configuration 200 for securing the tray 130 with the cross-rail 132 when the cross-rail 132 is constructed of a thermoplastic composite. That is, when the cross-rail 132 is constructed of metal, the electrically conductive plate 172 is omitted from the one-step induction welding assembly configuration, and the upper surface 186 of the layer of electrically insulating material 76 directly contacts the outer surface 148 of the base 134 of the tray 130. However, in some embodiments, the tray 130 may be secured to the cross-rail 132 without the electrically conductive plate 172 when the cross-rail 132 is constructed of a thermoplastic material.

The one-step induction welding assembly configuration 200 also includes a die 188 that exerts a clamping force F_{c} against the flange 140 of the cross-rail 132. In the example as shown in FIG. 8, the clamping force F_{c} is oriented in a downwards direction towards the cross-rail 132, and the die 188 includes individual blocks 190 that each exert the clamping force F_{c} against either the left side and the right side 192 of the flange 140. The plurality of induction coils 166 exerts a force Fₒ that directly opposes the clamping force F_{c} to retain the tray 130 and the cross-rail 132 in place as the tray 130 and the cross-rail 132 are joined together at the joining interface 164.

Referring to both FIGS. 5 and 8, it is to be appreciated that both the one-step induction welding assembly configuration 100 shown in FIG. 5 and the one-step induction welding assembly configuration 200 shown in FIG. 8 join a tray 30, 130 together with a cooling component, where the cooling component is either the cooling plate 32 shown in FIG. 5 or the cross-rail 132 shown in FIG. 8. It is to be appreciated that the cooling component may be constructed of either metal or thermoplastic composite material.

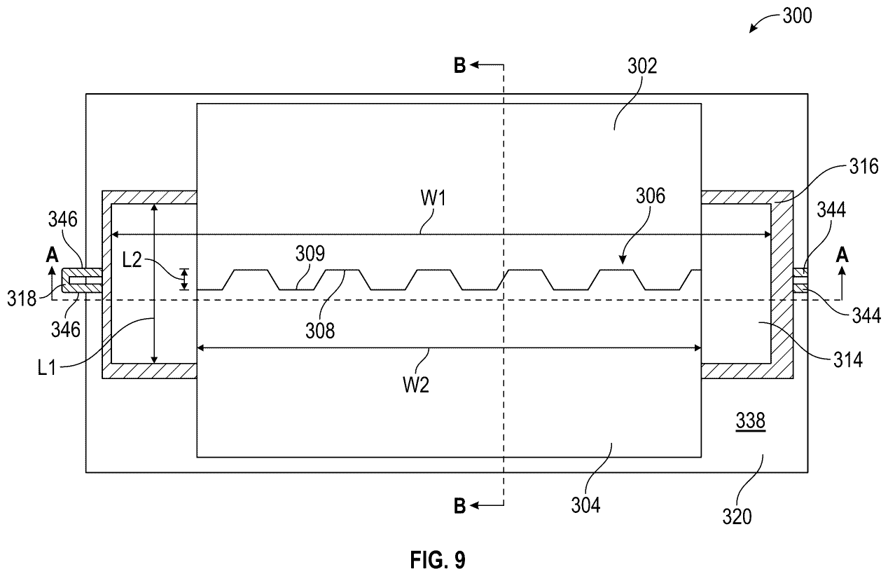

FIG. 9 is a top view of another embodiment of the one-step welding assembly configuration 300 for joining a first component 302 and a second component 304 to one another together. It is to be appreciated that the first component 302 and the second component 304 are positioned coplanar with respect to one another, where both components 302, 304 each include about the same thickness. As seen in FIG. 9, the first component 302 and the second component 304 are joined together at an interlocking joining interface 306 where a mating edge 308 of the first component 302 and a mating edge 309 of the second component 304 include complimentary interlocking profiles that correspond to one another.

In the exemplary embodiment as shown in FIG. 9, the interlocking joining interface 306 includes a trapezoidal profile, however, it is to be appreciated that the interlocking joining interface 306 is not limited to the trapezoidal profile as illustrated. Indeed, the interlocking joining interface 306 may be any other type of joint including interlocking profiles such as, but not limited to, a dovetail profile. The first component 302 and the second component 304 may be, for example, the base of a tray that is part of the battery enclosure 12 shown in FIG. 1.

The first component 302 and the second component 304 are both constructed of a thermoplastic composite. In one embodiment, the thermoplastic composite includes a fiber reinforcement and a matrix material. In an embodiment, the fiber reinforcement of the thermoplastic composite is electrically conductive. For example, the thermoplastic composite may include continuous carbon fiber, discontinuous carbon fiber, both continuous and discontinuous carbon fibers, or metal coated glass fibers to facilitate induction heating. In another embodiment, the fiber reinforcement is constructed of an electrically non-conductive material such as, for example, glass fiber. In still another embodiment, the thermoplastic composite does not include a fiber reinforcement.

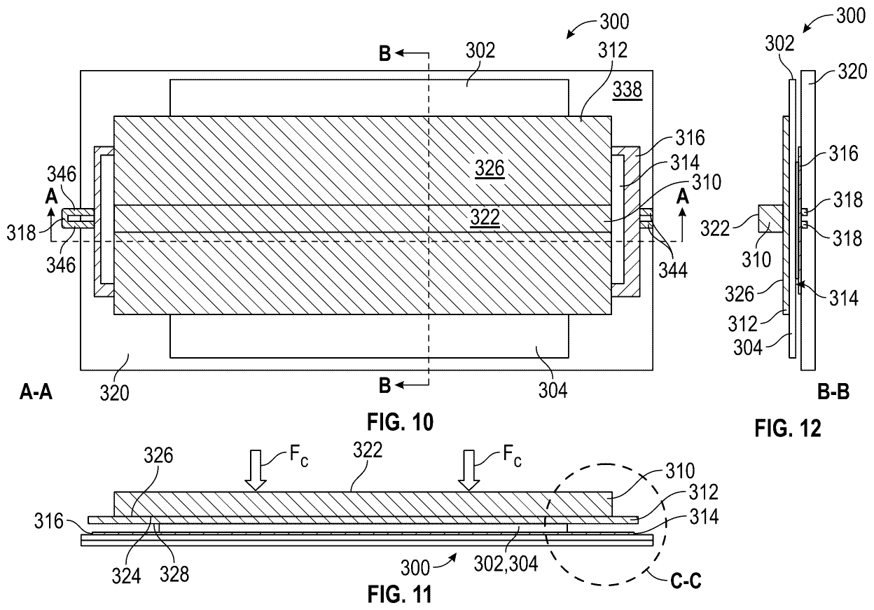

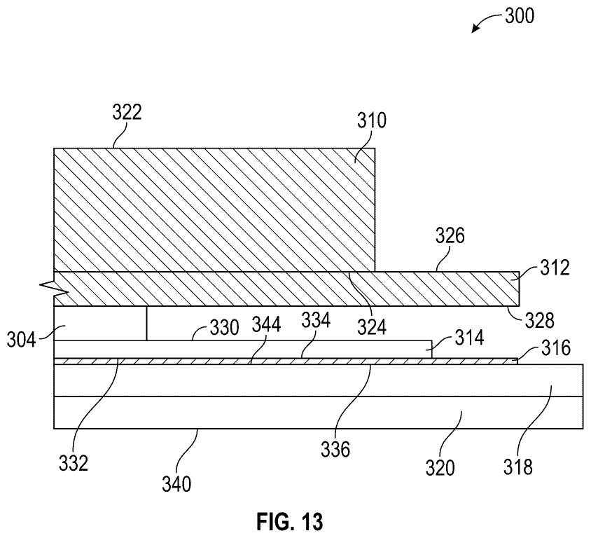

It is to be appreciated that FIG. 9 is an illustration of the one-step welding assembly configuration 300 where an insulating clamp 310 and a constraining plate 312 (shown in FIG. 10) have been omitted to reveal the interlocking joining interface 306 between the first component 302 and the second component 304. FIG. 10 is a top view of the one-step welding assembly configuration 300, FIG. 11 is taken along section A-A in FIG. 10, FIG. 12 is taken along section B-B in FIG. 10, and FIG. 13 is the detail of Area C-C in FIG. 11.

Referring to FIGS. 9, 10, and 13, the one-step welding assembly configuration 300 includes the insulating clamp 310, the constraining plate 312, the first and second components 302, 304, an electrically conductive plate 314, an insulating sheet 316, and an induction coil 318 that is embedded within a base plate fixture 320. In the embodiment as shown in the figures, the first and second components 302, 304 are held in place between the constraining plate 312 and the electrically conductive plate 314 and a clamping force F_{c} (FIG. 10) is exerted against the first and second components 302, 304 by the insulating clamp 310. In an embodiment, the electrically conductive plate 314 may be omitted, and the first and second components 302, 304 are held in place between the constraining plate 312 and the insulating sheet 316.

The insulating clamp 310 is constructed of an electrically insulating material such as, but not limited to, glass reinforced epoxyG-10. Referring to FIGS. 9, 10, 12, and 13, the insulating clamp 310 includes an elongated rectangular profile defining an upper surface 322 and a lower surface 324, where the lower surface 324 of the insulating clamp 310 contacts an upper surface 326 of the constraining plate 312. Referring specifically to FIGS. 9 and 10, the insulating clamp 310 is positioned to align with and exert the clamping force F_{c} upon the interlocking joining interface 306 between the first component 302 and the second component 304 (shown in FIG. 9). Specifically, the insulating clamp 310 is positioned against the upper surface 326 of the constraining plate 312 such that the insulating clamp 310 extends along the total width W2 of the interlocking joining interface 306.

The constraining plate 312 includes a planar profile including the upper surface 326 and a lower surface 328. The lower surface 328 of the constraining plate 312 represents a level surface for exerting the clamping force F_{c} against the first and second components 302, 304. The constraining plate 312 is constructed of a thermally insulating material such as, for example, glass fiber reinforced epoxy G-10. In embodiments, the constraining plate 312 may be constructed of metals such as aluminum or steel as well.

Referring to FIG. 13, the electrically conductive plate 314 includes a planar profile defining an upper surface 330 and a lower surface 332, where the upper surface of the electrically conductive plate 314 contacts the first and second components 302, 304. The electrically conductive plate 314 is constructed of an electrically conductive material that is heated during induction welding such as, but not limited to, steel or aluminum. It is to be appreciated that heating of the electrically conductive plate 314 facilitates the joining of the first component 302 and the second component 304 together at the joining interface 306 (FIG. 9). In an embodiment, the electrically conductive plate 314 is constructed of at least one of the following materials for providing EMI shielding: a metal film, sheet metal, or a metallic mesh material and the electrically conductive plate 314 is joined to the first component 302 and the second component 304 during the one-step induction welding process. In embodiments where the first component 302 and the second component 304 are constructed of a thermoplastic material including electrically conductive fiber reinforcement, the electrically conductive plate 314 is optional and may be omitted. However, if the first component 302 and the second component 304 are constructed of a thermoplastic material including non-conductive fiber reinforcement, or no fiber reinforcement at all, then the electrically conductive plate 314 is required.

It is to be appreciated that the specific electrically conductive material that the electrically conductive plate 314 is constructed of depends upon factors such as, but not limited to, thermal and electrical conductivity. Referring specifically to FIG. 9, it is to be appreciated that in an embodiment the electrically conductive plate 314 includes a length L1 and a width W1 that extend beyond a total length L2 and the total width W2 of the interlocking joining interface 306 that joins the first component 302 and the second component 304 together.

Referring specifically to FIG. 13, the insulating sheet 316 includes a planar profile defining an upper surface 334 and a lower surface 336, where the upper surface 334 of the insulating sheet 316 contacts the lower surface 332 of the electrically conductive plate 314 and the lower surface 336 of the insulating sheet 316 is seated against the base plate fixture 320. In the event the electrically conductive plate 314 is omitted, then the upper surface 334 of the insulating sheet 316 contacts the first and second components 302, 304. The insulating sheet 316 is constructed of electrically insulating materials. The insulating sheet 316 is provided to electrically isolate the induction coil 318 from the first and second components 302, 304 as well as the electrically conductive plate 314.

The induction coil 318 is recessed within the base plate fixture 320. The base plate fixture 320 includes a planar profile defining an upper surface 338 (shown in FIGS. 9 and 10) and a lower surface 340, where an outer surface 344 of the induction coil 318 is exposed when viewed along the upper surface 338 of the base plate fixture 320. The base plate fixture 320 is constructed from an electrically insulating material such as, for example, a glass reinforced epoxy G-10. It is to be appreciated that the base plate fixture 320 remains stationary as the clamping force F_{c} (FIG. 10) is exerted against the first and second components 302, 304 by the insulating clamp 310.

In the embodiment as shown in FIGS. 9, 10, and 13, the induction coil 318 includes two legs 346 that are oriented parallel with respect to one another. When energized by a radio-frequency electric current created by an energy source (not shown), the induction coil 318 creates an electromagnetic field that generates heat and joins the first component 302 and the second component 304 together at the interlocking joining interface 306 while the clamping force F_{c} (FIG. 10) is exerted against the first and second components 302, 304 by the insulating clamp 310.

Referring generally to the figures, the disclosed embodiments of the one-step induction welding assembly configuration provide various technical effects and benefits. Specifically, the one-step induction welding assembly configuration provides an approach for joining thermoplastic components, or thermoplastic and metal components that are part of a battery enclosure together as part of a one-step process. The disclosed approach also describes surface treatments that enhance joining between components, which obviates the need for an adhesive layer between components. Eliminating adhesive between components may reduce assembly package space as well as improve the capability to reclaim and recycle materials from the battery enclosure.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A one-step induction welding assembly configuration for a battery enclosure, the one-step induction welding assembly configuration comprising:
a tray constructed of a constructed of thermoplastic composite material, wherein the tray is part of the battery enclosure;
a cooling plate constructed of one of the following: thermoplastic composite material and metal, wherein the cooling plate is joined to the tray at a joining interface, and wherein the cooling plate is part of the battery enclosure;
a plurality of induction coils that are energized to create an electromagnetic field that generates heat and joins the tray and the cooling plate together at the joining interface;
a layer of electrically insulating material disposed directly underneath the plurality of induction coils; and
a die that exerts a clamping force against the tray of the battery enclosure, wherein the plurality of induction coils exerts a force that directly opposes the clamping force to retain the tray and the cooling plate in place.

2. The one-step induction welding assembly configuration of claim 1, wherein the cooling plate is constructed of the thermoplastic composite material.

3. The one-step induction welding assembly configuration of claim 2, comprising an electrically conductive plate including an upper surface and a lower surface, wherein the upper surface of the electrically conductive plate contacts a lower surface of the layer of electrically insulating material and the lower surface of the electrically conductive plate contacts an upper surface of the cooling plate.

4. The one-step induction welding assembly configuration of claim 1, wherein a thermal resistance through the cooling plate does not exceed 3.0×10⁻³ m²KW⁻¹ at 65° C.

5. The one-step induction welding assembly configuration of claim 1, wherein the cooling plate is constructed of metal.

6. The one-step induction welding assembly configuration of claim 5, wherein a lower surface of the layer of electrically insulating material contacts an upper surface of the cooling plate.

7. The one-step induction welding assembly configuration of claim 1, wherein the tray includes base, and wherein a plurality of cooling features extends along at least a portion of the base.

8. The one-step induction welding assembly configuration of claim 7, wherein the plurality of cooling features include a plurality of cooling channels, and wherein each cooling channel is a passageway shaped to receive a cooling medium.

9. The one-step induction welding assembly configuration of claim 8, wherein raised surfaces are interposed between the plurality of cooling channels disposed along the base of the tray.

10. The one-step induction welding assembly configuration of claim 9, wherein the raised surfaces interposed between the plurality of cooling channels located along the base of the tray contact a lower surface of the cooling plate at the joining interface.

11. The one-step induction welding assembly configuration of claim 9, wherein the raised surfaces of the tray include one of the following: a higher average surface roughness value when compared to a remaining portion of the tray, and an increased surface energy when compared to the remaining portion of the tray.

12. The one-step induction welding assembly configuration of claim 1, wherein the cooling plate includes an upper surface that includes one of the following: a higher average surface roughness value when compared to a remaining portion of the cooling plate, and an increased surface energy when compared to the remaining portion of the cooling plate.

13. The one-step induction welding assembly configuration of claim 1, wherein the tray is constructed of a thermoplastic composite laminate including a thermoplastic composite layer and at least one of the following: a thermal runaway propagation (TRP) protective layer, TRP protective materials, and an electromagnetic interference (EMI) shielding layer.

14. A one-step induction welding assembly configuration for a battery enclosure, the one-step induction welding assembly configuration comprising:
a tray constructed of a constructed of thermoplastic composite material, wherein the tray is part of the battery enclosure;
a cross-rail constructed of one of the following: thermoplastic composite material and metal, wherein the cross-rail is joined to the tray at a joining interface, and wherein the cross-rail is part of the battery enclosure;
a plurality of induction coils that are energized to create an electromagnetic field that generates heat and joins the tray and the cross-rail together at the joining interface;
a layer of electrically insulating material disposed directly underneath the plurality of induction coils; and
a die that exerts a clamping force against the cross-rail of the battery enclosure, wherein the plurality of induction coils exerts a force that directly opposes the clamping force to retain the tray and the cross-rail in place.

15. The one-step induction welding assembly configuration of claim 14, wherein the cross-rail includes a flange.

16. The one-step induction welding assembly configuration of claim 14, comprising an electrically conductive plate disposed between the tray of the battery enclosure and the layer of electrically insulating material.

17. A one-step induction welding assembly configuration for a battery enclosure, the one-step induction welding assembly configuration comprising:
a first component and a second component that are positioned coplanar with respect to one another, wherein the first component and the second component are joined together at an interlocking joining interface;
an induction coil energized to create an electromagnetic field that generates heat and joins the first component and the second component together at the interlocking joining interface;
an insulating clamp constructed of an electrically insulating material, wherein the insulating clamp exerts clamping force upon the interlocking joining interface between the first component and the second component; and
a base plate fixture constructed of an electrically insulating material, wherein the induction coil is recessed within the base plate fixture and the base plate fixture remains stationary as the clamping force is exerted against the first and second components by the insulating clamp.

18. The one-step induction welding assembly configuration of claim 17, comprising an electrically conductive plate constructed of an electrically conductive material and including a planar profile defining an upper surface and a lower surface, wherein the upper surface of the electrically conductive plate contacts the first component and second component.

19. The one-step induction welding assembly configuration of claim 18, wherein the electrically conductive plate includes a length and a width that extend beyond a total length and a total width of the interlocking joining interface that joins the first component and the second component together.

20. The one-step induction welding assembly configuration of claim 18, wherein the electrically conductive plate is constructed of at least one of the following materials for providing EMI shielding: a metal film, sheet metal, and a metallic mesh material, and wherein the electrically conductive plate is joined to the first component and the second component.
